(19) United States
(12) Patent Application Publication
(10) Pub. No.: US 2026/0311086 A1
(43) Pub. Date: Oct. 8, 2026

(54) MULTI-AI AGENTS FOR ADAPTABLE TASK PLANNING IN CONSTRUCTION ROBOTS

(71) Applicant: VIRGINIA TECH INTELLECTUAL PROPERTIES, INC., Blacksburg, VA (US)

(72) Inventors: Hossein Naderi Aghbash, Blacksburg, VA (US); Alireza Shojaei Kol Kachi, Blacksburg, VA (US)

(21) Appl. No.: 19/638,654

(22) Filed: Apr. 3, 2026

Related U.S. Application Data
(60) Provisional application No. 63/782,902, filed on Apr. 3, 2025.

(51) Int. Cl. G06Q 10/0631; G06Q 50/08

(52) U.S. Cl. CPC G06Q 10/063118; G06Q 50/08

(57) ABSTRACT

Disclosed are various embodiments for a multi-agent system for adaptable task planning in construction robots. In one or more embodiments, an autonomous construction robot may receive, from the one or more sensors, input data including real-time data about a construction environment. The autonomous construction robot may also generate, by one or more artificial intelligence (AI) agents, a plan to perform a task within the construction environment based on the real-time data. The autonomous construction robot may also generate, by the one or more AI agents and based on the plan, an execution instruction for the autonomous construction robot to perform the task within the construction environment. The autonomous construction robot may also autonomously perform the task within the construction environment.

### CROSS-REFERENCE TO RELATED APPLICATIONS

This application claims the benefit of U.S. Provisional Patent Application No. 63/782,902, filed Apr. 3, 2025, which is incorporated by reference herein in its entirety.

### BACKGROUND

Autonomous construction robots offer the potential to handle repetitive tasks, improving productivity and helping to enable construction in settings not currently feasible (e.g., for use in disaster relief, extra-terrestrial construction, or other dangerous and challenging environments). However, when it comes to robotic adoption in construction sites, there are several challenges that impede these robots from achieving their full potential, including technological, economic, and organizational challenges.

With technological challenges, several studies have identified the lack of versatility, adaptability, and generalizability as major challenges preventing current construction robotic technologies from reaching the desired level of autonomy. One major category of these technologies is pre-programmed robots that can automatically perform single tasks with high precision. However, these robots are deterministically programmed for a specific construction task, thus even small variations in tasks or environmental conditions require significant reprogramming.

Another category is data-driven paradigms, including machine learning, reinforcement learning, and imitation learning, which struggle with similar adaptability and generalizability issues. These approaches rely on narrowly defined task-specific datasets, which restrict their effectiveness in construction environments that are often unpredictable and characterized by unique situations. When encountering a scenario that was not included in their training data, these approaches typically require retraining and dataset adjustment to adapt. Moreover, construction companies view their data as a valuable asset and are often reluctant to share it for model training purposes, which further complicates efforts to improve adaptability with these data-driven approaches.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 shows an exemplary multi-agent system for adaptable task planning in construction robots, according to various embodiments of the present disclosure.

FIG. 2 shows various agent configurations for the system of FIG. 1, according to various embodiments of the present disclosure.

FIG. 3 shows a framework implemented by the construction robot of FIG. 1, according to various embodiments of the present disclosure.

FIG. 4 shows a flow diagram for perceptual and regulation tasks performed by the construction robot of FIG. 1, according to various embodiments of the present disclosure.

FIG. 5 shows a flow diagram for safety and report generation tasks performed by the construction robot of FIG. 1, according to various embodiments of the present disclosure.

FIG. 6 shows an example of a use case performed by the construction robot of FIG. 1, according to various embodiments of the present disclosure.

FIG. 7 is a method for multi-agents for adaptable task planning in construction robots, according to various embodiments of the present disclosure.

FIG. 8 is a schematic block diagram that provides one example illustration of a computing environment, according to various embodiments of the present disclosure.

### DETAILED DESCRIPTION

Disclosed herein are multi-agents for adaptable task planning in construction robots. Particularly, the autonomous construction robot includes on-board AI agents that work in conjunction to automate different aspects of task planning and robotic action execution based on unstructured environmental conditions. While tasks with high analyzability are often the focus of automation in structured environments such as manufacturing, the autonomous robots described herein are specifically configured to operate autonomously in unstructured environments involving non-routine and unpredictable tasks, such as construction environments. Specifically, described herein are the examples of painting, laying tile, and performing a safety inspection, however, the robots described herein may be used for any other type of construction task, or even any other type of unstructured task generally. The autonomous capabilities of the robots described herein provide significant advantages over existing robots that employ rigid if-then statements, as each instance typically requires a unique approach for these existing robots.

One existing solution to address the aforementioned adaptability challenges, specifically relating to construction robots, is to integrate human cognitive capabilities with robots through teleoperation paradigms. However, these approaches also fall short of achieving desired autonomy, as their dependency on human operators, as well as the potential latency associated with sending and receiving data, limits their performance and productivity. For example, even slight connection delays can significantly impede robot performance in remote locations

While adaptability can be applied to a wide range of functions in construction robotics, task planning serves as a foundational element that enables autonomous robots to function adaptively in dynamic environments. Task planning involves high-level reasoning to determine which actions to take and in what sequence, based on the specific situation at hand. This process is the first step in bridging abstract goals with actionable tasks, making it essential for bringing task-level autonomy to robotics.

For example, a robot assigned to paint a wall might plan the following steps: pick up a roller, dip it into the paint can, and apply the paint to the wall. This high-level planning defines the sequence of actions required to complete the task. However, it is not cost-effective for construction companies, especially small companies such as specialty contractors, to invest in robots that can only perform a certain type of work and remain inactive during other phases of a project. Instead, adaptable and multi-task robots capable of performing various tasks are needed. In the absence of adaptable task planning, when the robot is needed for another task, such as floor tiling, pre-programmed and conventional data-driven approaches often fail because they require significant reprogramming or retraining to address the unpredictable events that are inherent in construction sites. By contrast, an adaptable and generalizable planning system would allow the robot to interpret the new task, identify the required tools and steps (e.g., laying adhesive, placing tiles, and ensuring alignment), and execute the task successfully. Such adaptability mirrors human problem-solving and underscores the need for improving the adaptability and generalizability of task planning systems for construction robots.

Recently, pre-trained Foundation Models, such as Large Language Models (LLMs), have been employed as Artificial Intelligence (AI) agents to demonstrate some level of adaptability and generalizability. Unlike traditional AI systems trained on task-specific datasets, these models are trained on massive, internet-scale datasets. This training approach, combined with the Transformer architecture, enabled the models to show an understanding and find zero-shot solutions to downstream tasks that were not explicitly present in their training data. These qualities of generalizability and adaptability can be seen as a potential solution to address the adaptability challenges in task planning for construction robotics.

However, there are significant limitations to Foundation Model applications in the context of construction robotics. On one hand, state-of-the-art API-based (closed-source) models are expensive to use as task-planning tools for construction robots. On the other hand, open-source, powerful models require high computational power that is rarely available on most construction robots. Additionally, recent studies indicate that lightweight open-source models often fall short in reasoning capabilities, limiting their effectiveness for task planning in complex environments, such as construction sites. Emerging research suggests that deploying multiple LLMs in cooperative systems can improve performance in complex cognitive and reasoning tasks by breaking problems into smaller components and engaging in debate or collaboration.

Task planning in robotics refers to the process of creating sequences of actions for robots to achieve specific goals autonomously. These plans are typically generated based on models that describe the environment and the robot's capabilities. Several methods have been developed to enable robot task planning. Classical planning frameworks define tasks by specifying preconditions and effects for each action, allowing robots to plan by sequencing actions from the initial state to the goal. These classical methods assume a fully observable and deterministic environment, which makes them effective for structured problems but limited in real-world construction applications due to their limitation in handling incomplete information.

More advanced methods, such as temporal planning and probabilistic planning, are employed to address classical deterministic challenges. Temporal planning considers the duration and timing of actions, essential for coordinating activities in dynamic environments. Probabilistic planning, on the other hand, incorporates uncertainty by modeling environments with unpredictable outcomes, using techniques such as Markov Decision Processes and Partially Observable Markov Decision Processes. More recent advancements have explored the integration of data-driven techniques, including reinforcement learning and imitation learning, to learn from data and enhance task planning capabilities in complex situations. However, these data-driven paradigms suffer from training on narrow and specific-task datasets, hindering their applications in real-world situations where robots face lots of objects and elements that are not available in the dataset. For example, a construction robot tasked with sorting debris after demolition may encounter a wide variety of unexpected materials not represented in its training dataset, resulting in ineffective task planning. This lack of adaptability and generalizability underscores the need for further research to develop more generalizable task planning methods capable of addressing the unpredictable and diverse challenges construction robots face.

AI agents, built upon foundation models such as LLMs and Vision-Language Models (VLMs), are revolutionizing various domains with their capabilities to find solutions for downstream tasks that are not included in their training dataset (zero-shot solutions). Unlike previous specialized AI models that were trained on task-specific data to perform certain tasks, these very large neural networks are trained on a broad and massive scale using internet-scale unlabeled data in an unsupervised manner. This training approach makes them adaptable to a wide range of general downstream tasks.

Building on advances of single agents and inspired by collaboration in human teams for solving complex tasks, many studies are focusing on multi-AI agent systems to address more complex challenges. In this approach, LLM-powered agents take on multiple roles and tasks, collaborating to achieve common goals similar to human teams. Recent studies suggest that such multi-agent systems can enhance factuality and reasoning, planning, and divergent thinking. Building on these findings, this study hypothesizes that the integration of multi-agent AI systems can improve the adaptability of task planning in construction robotics.

In the context of construction robotics, automation and autonomy represent two distinct levels of robotic functionality and decision-making (or cognitive) capability. Automation refers to the execution of predefined tasks with limited human intervention. Automated systems follow specific instructions or rules to perform repetitive or structured activities, such as material handling or precise assembly tasks. These systems are typically limited to the tasks they are explicitly programmed to perform and lack the ability to adapt to variations or unforeseen circumstances without human input. Conversely, autonomy encompasses a higher level of decision-making (cognitive) and generalizability (adaptability). Autonomous robots have the capability to perceive their environment, make informed decisions, and execute actions independently to achieve specific goals. Autonomy involves complex cognitive processes such as task planning, problem-solving, and real-time adaptation to dynamic and unstructured environments commonly found on construction sites. Autonomy enables robots to handle diverse tasks and unpredictable scenarios, enhancing their effectiveness in complex construction tasks.

Various taxonomies and classification systems have been developed to conceptualize autonomy. For example, the Society of Automotive Engineers (SAE) introduced a scale for autonomous vehicles, ranging from Level 0 (manual control) to Level 5 (fully autonomous). In most frameworks, a level of autonomy signifies a function that was previously carried out by a human. However, these discrete classification systems suggest an “all-or-nothing” approach to robotic autonomy, which does not fully capture the multi-disciplinary nature of autonomy. Instead, autonomy is best understood as existing along a continuum, ranging from low to high across different functions, reflecting the varied and flexible roles autonomy can play in different contexts.

Generalizability (or adaptability and versatility) is a missing characteristic in existing construction robots. In the robotic context, generalizability refers to the ability of a robot or agent to apply learned skills or behaviors to new, previously unseen tasks. This ability is critical as it allows robots to be more adaptable, flexible, and efficient in various situations without requiring explicit reprogramming or retraining for each unique task. This definition closely aligns with related terms such as versatility, flexibility, and adaptability in construction settings, which are frequently highlighted as critical yet often missing characteristics

Generalizability and autonomy are intrinsically connected in the context of robotics, with generalizability serving as an inherent characteristic of systems exhibiting high autonomy. This relationship is evident in various definitions of autonomy. Autonomy is not simply about performing a task independently; it is fundamentally about responding to dynamic conditions and unforeseen challenges. In most existing studies, robots receive detailed, written commands as input that specify the task's intention and the objects required to use, implying a need for human intervention to fully interpret and plan the task toward its goals. For example, some existing robots may be instructed with commands like “bring coffeepot and cupcake to the coffee table.” This clearly demonstrates that the robot requires human intervention to identify relevant objects and understand the task's goal. Similarly, some existing robots are provided an input, such as “I spilled my drink, can you help,” indicating that the robot relied on human-provided sentences to understand the task's intention. These examples collectively demonstrate that current approaches, despite improving the general applicability of the robot, are still dependent on human intervention for object identification and goal understanding, situating them in the middle of the planning autonomy of robots. However, our study aims to take one step further toward higher autonomy by minimizing the need for detailed human instructions.

Rather than providing the robot with sentence commands and instructions, the approach described herein may provide a single word that shows the robot's role in the task. In this method, the robot may autonomously reason and determine the required plan based on the situation without relying on specific keywords in the command. To this end, this approach employs a collaboration between a groups of VLMs and LLMs to identify the task goals, best objects for task completion, and effective functions to perform the assigned role. This approach provides a better understanding of multi-AI agent behavior for robot task planning and enables autonomous functionality of these construction robots (and other types of robots in unstructured, dynamic environments).

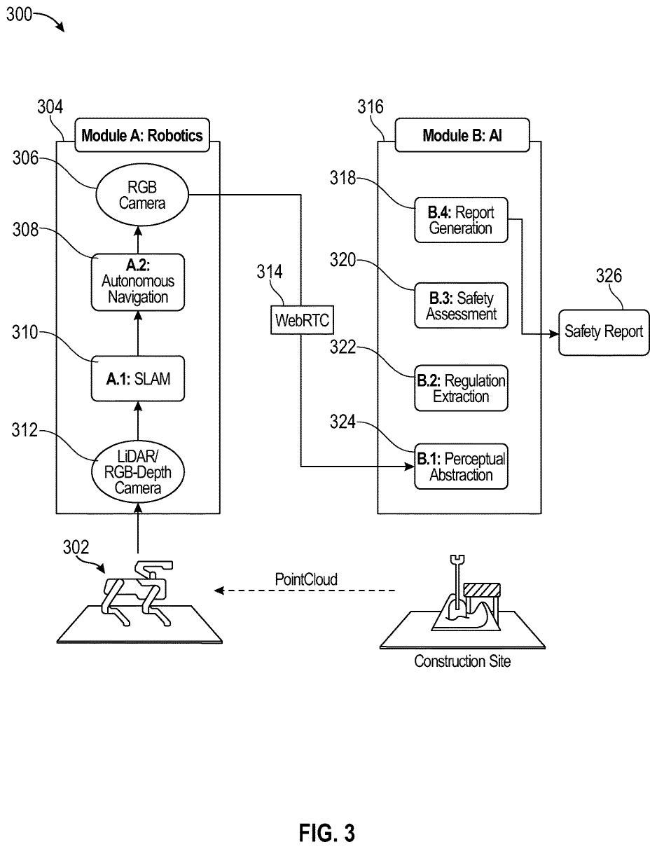

One specific use case of the autonomous construction robots described herein is in the safety assessment context (illustrated in FIGS. 3-6). With the rapid growth of sensing technologies in recent decades, various technologies are utilized in studies for automated safety inspection. Some studies use sensor-based systems for real-time alert of overhead hazards. However, these existing approaches rely on sensors installed on construction entities and around predefined hazards, which is not suitable in rapidly changing construction sites. Additionally, the need for constant reconfiguration of sensors to adapt to shifting environments can lead to inefficiencies. Therefore, more flexible and adaptive solutions are needed to ensure safety in dynamic construction environments.

Another group of existing approaches utilizes Unmanned Aerial Vehicle (UAVs) and Quadruped Robots equipped with cameras for automated inspection. These mobile devices move faster than humans and can access hard-to-reach places and perform continuous monitoring. These studies can be categorized into two overall groups, each of which has its own challenges. A first existing approach uses the UAVs and Quadruped robots with a camera to reduce human transmission to hazardous work areas, and use teleoperation to recognize the hazardous area and to generate the report and perform actions. A second existing approach equipped robots with computer vision techniques to automate one specific task in construction inspection. For example, employing computer vision techniques to detect unguarded openings from video streams transmitted by UAVs.

These existing approaches to safety assessment in construction robots, however, have limitations. The first existing approach, which aims to reduce manual work through teleoperated quadruped robots and UAVs, still relies heavily on human intervention for controlling the robots, identifying inspection issues, generating reports, and taking corrective actions. The second existing approach, which improves the recognition process using conventional computer vision techniques, also presents limitations that need further exploration. Traditional computer vision methods require extensive, diverse image datasets, but construction companies are often reluctant to share site-specific images, limiting the potential of these techniques. These methods are typically trained on narrowly defined, task-specific datasets, making them less effective in dynamic, rapidly changing environments. They require frequent re-training and adjustments for a broad range of safety inspection tasks. Although these methods reduce dependence on manual inspection, they still require human intervention for controlling robots and UAVs, as well as for reviewing and producing inspection reports.

To address these gaps, the approach described herein in the context of safety assessments has provided the following improvements over existing systems: (1) introduction of a regulation-aware approach that detects safety violations by tying visual evidence to OSHA-based rules and producing traceable, cited outputs; (2) strong recall with competitive precision across scenarios, prioritizing missed-hazard reduction while keeping false alarms manageable; and (3) a transparent, auditable pipeline whose intermediate outputs make the reasoning easy to follow, while remaining zero-shot and modular so it can adapt to new tasks without task-specific retraining.

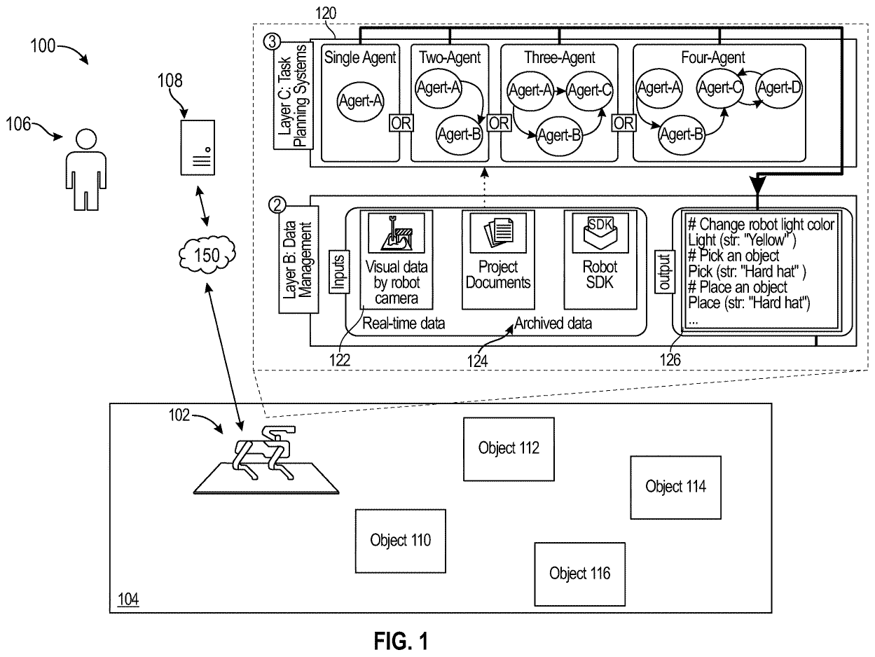

Turning to the figures, FIG. 1 shows an exemplary multi-agent system 100 for adaptable task planning in construction robots. In embodiments, the system 100 may include an autonomous construction robot 102 (also more generally referred to as a “robot” or the like herein) that is provided in a construction environment 104. The system may also optionally include a remote computing device 108, such as a remote server, for example.

In embodiments, the autonomous construction robot 102 may be a robot that is configured to autonomously perform specific types of construction tasks in the construction environment 104 without requiring manual intervention by a user 106. As one example, the autonomous construction robot 102 may be configured to autonomously perform painting tasks within the construction environment 104. As another example, the autonomous construction robot 102 may be configured to autonomously lay tile on a floor within the construction environment 104. The autonomous construction robot 102 may instead be configured to perform any other type of autonomous task. Additionally, in some instances, the autonomous construction robot 102 may be configured to perform multiple different types of tasks.

To perform such task(s), the autonomous construction robot 102 may be configured to interact with different types of objects within the construction environment 104 (FIG. 1 shows objects 110-116, however, any other number of objects may be present, and the objects may be located at various positions within the construction environment 104). For example, if the autonomous construction robot 102 is configured to perform painting tasks, the object 110 may be a bucket of paint that the autonomous construction robot 102 uses to acquire the paint to perform the painting task. Objects 112-116 may be obstacles (for example, furniture, structural elements within the construction environment 104, etc.) that are present in the construction environment 104 that the autonomous construction robot 102 needs to avoid when navigating the construction environment 104 to perform the painting task. The objects may also be any other types of objects that the autonomous construction robot 102 may interact with within the construction environment 104.

The autonomous construction robot 102 may receive and/or store one or more inputs and may generate an output. The one or more inputs may include, for example, real-time data 122 and archived data 124. Real-time data 122 may include any data captured by the autonomous construction robot 102 as the autonomous construction robot 102 navigates the construction environment 104. For example, the real-time data 122 may include visual data captured by one or more cameras of the autonomous construction robot 102, audio data captured by a microphone of the autonomous construction robot 102, or any other types of input data captured using any other types of sensor(s).

The archived data 124 may include data other than the real-time data captured by the autonomous construction robot 102, such as project documentation (for example, agreements, safety regulations, schedules, site-specific information required by the cognition platform, etc.). In some instances, some or all of the archived data 124 may be provided by a user 106. To provide seamless integration with robot execution systems, the archived data 124 may also include information from robot libraries and documentation, such as Robot Software Development Kits (SDKs) or the Robot Operating System (ROS) Packages, Nodes, and Topics. The output 126 may include a task plan that is generated, which the autonomous construction robot 102 can execute to perform actions based on its assigned role. Specifically, the output 126 may be instructions that may be executed by the autonomous construction robot 102 to perform an autonomous task or portions of an autonomous task within the construction environment 104.

The autonomous construction robot 102 may be equipped with any suitable hardware components used to assist the autonomous construction robot 102 in performing tasks. In a particular example, the autonomous construction robot 102 may be a quadruped robot with various attachments. In this embodiment, the quadruped robot may have a built-in RGB camera, a robotic arm, and a LiDAR device that is attached to the autonomous construction robot 102. It should be noted that this is merely one exemplary configuration for an autonomous construction robot 102 as described herein, and the autonomous construction robot 102 may be configured in any other suitable manner using any other hardware components that allow the autonomous construction robot 102 to perform various tasks.

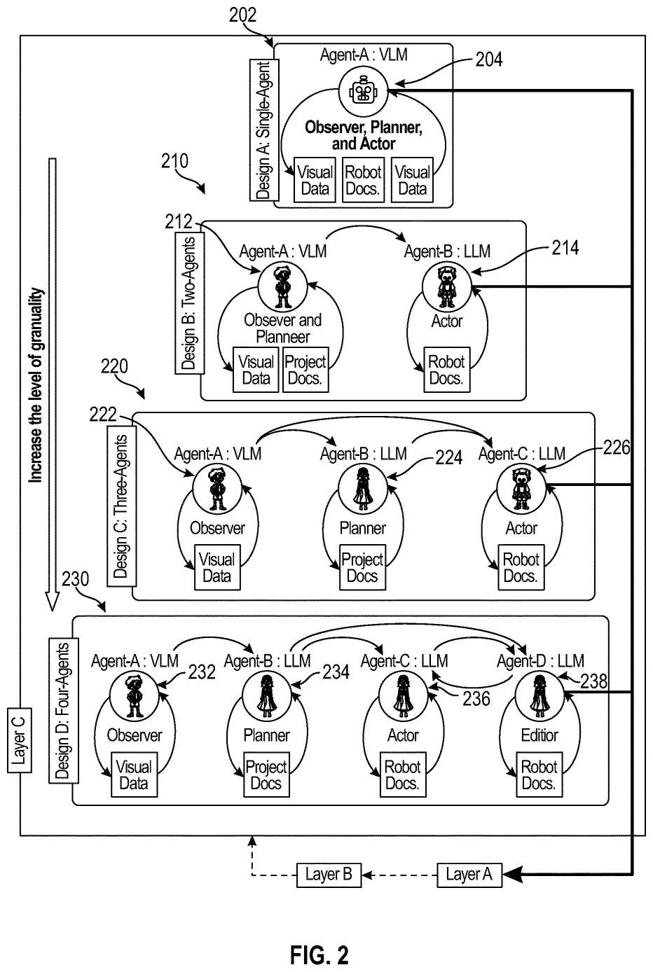

As indicated above, the autonomous robots described herein are configured to operate autonomously to perform tasks in unstructured environments, such as construction environments. Existing autonomous robots are typically found in structured environments, such as manufacturing environments, where conditions are predictable and static execution programs may be used. To facilitate this improvement, the autonomous construction robot 102 may also include one or more AI agents 120 that are leveraged to generate instructions for the autonomous construction robot 102 to execute. FIG. 1 illustrates multiple different configuration options in which a varying number of AI agents 120 are used in conjunction. different designs proposed and analyzed in this paper. FIG. 2 shows a more detailed depiction of the different types of agents and the manner in which the agents may interact for each of these configuration options, and is described in further detail below.

In some cases, some or all of the processing performed by the autonomous construction robot 102 may be delegated to the remote computing device 108, which may be in data communication with the autonomous construction robot 102 via a network 150 (which may be any type of wired and/or wireless network using any form of communication protocol). The network 150 includes, for example, the Internet, intranets, extranets, wide area networks (WANs), local area networks (LANs), wired networks, wireless networks, or other suitable networks, etc., or any combination of two or more such networks. For example, such networks may comprise satellite networks, cable networks, Ethernet networks, and other types of networks. Accordingly, the autonomous construction robot 102 may also include a networking interface that allows the autonomous construction robot 102 to perform communications via any suitable wired or wireless network connection using any suitable communication protocol.

For example, in some embodiments, the one or more AI agents 120 may be located at the remote computing device 108 instead of the autonomous construction robot 102. In such embodiments, data from the autonomous construction robot 102 may be transmitted to the remote computing device 108, the one or more AI agents 120 may then analyze the data and produce outputs 126 that are transmitted back to the autonomous construction robot 102, and the autonomous construction robot 102 may perform autonomous tasks based on the received outputs 126. In some instances, the outputs may be provided as command instructions that are executable by the autonomous construction robot 102. However, this is not intended to be limiting and the outputs may instead be provided in another format that the autonomous construction robot 102 may then use to generate executable instructions. In some embodiments, the one or more AI agents 120 may be stored on the autonomous construction robot 102 itself and the processing may be performed by the autonomous construction robot 102. In further embodiments, processing tasks may be split between the autonomous construction robot 102 and the remote computing device 108. Although reference is made specifically to processing performed by the one or more AI agents 120, any other processing tasks described herein may be performed by the autonomous construction robot 102, the remote computing device 108, or a combination of the autonomous construction robot 102 and the remote computing device 108.

Additionally, it should be noted that while a single computing device 108 is shown, this is also not intended to be limiting, and there may instead be any other number of remote computing devices 108 (for example, multiple servers may receive information and process the information in parallel to improve latency). That is, the system 100 may comprise, for example, a server computer or any other system providing computing capability. Alternatively, the system 100 may employ a plurality of computing devices 108 that may be arranged, for example, in one or more server banks or computer banks or other arrangements. Such computing devices may be located in a single installation or may be distributed among many different geographical locations. For example, the system 100 may include a plurality of computing devices 108 that together may comprise a hosted computing resource, a grid computing resource and/or any other distributed computing arrangement. In some cases, the system 100 may correspond to an elastic computing resource where the allotted capacity of processing, network, storage, or other computing-related resources may vary over time.

FIG. 2 shows various AI agent configurations for the system 100 of FIG. 1 (the AI agents may be the same as, or similar to, the one or more AI agents 120 shown in FIG. 1). Particularly, FIG. 2 shows four different exemplary AI agent configurations, including a first configuration 202 in which a single AI agent is included in the autonomous construction robot, a second configuration 210 in which two AI agents are included in the autonomous construction robot, a third configuration 220 in which three AI agents are included in the autonomous construction robot, and a fourth configuration 230 in which four AI agents are included in the autonomous construction robot. It should be noted that although these four configurations are shown, there may be additional configurations including any other number of AI agents. In the figure, arrows indicate the collaboration and communication channels defined between the agents. In addition to inter-agent communication, each agent operates within its own data collection loop, allowing it to gather and refine specific data before collaboration and communicate it with other agents.

Within these configurations, each AI agent may be assigned a particular role that an adaptable robot task planner is expected to perform. For example, the roles may include observer, planner, actor, and editor. Depending on the number of AI agents included in each configuration, one or more of the AI agents may be responsible for performing several different roles (or one or more of the roles may not be included in a particular configuration with a lower number of AI agents). The most compact configuration is the first configuration 202, where a single agent 204 built on a VLM is responsible for generating robot executable task plans. This agent 204 generates executable action plans based on the images it observes.

In the second configuration 210, there are two agents, with the first agent 212 acting as an observer and planner, receiving visual data and generating the task plan. The second agent 214 converts the generated plan into machine-understandable code for execution by the autonomous construction robot. The third configuration 220 further refines the defined roles by introducing three distinct agents, each handling a specific task. The first agent 222 (observer role) perceives and describes the situation to the second agent 224 (planner role), which creates an action plan for the robot. The third agent 226 (actor role) then receives both the plan and the situation description, converting them into executable commands using the robot's documentation. Finally, the fourth configuration 230 also includes a fourth agent 238 (the editor agent), which proofreads the output from the third agent 236 (also the actor agent) and provides a refined version of the commands before they are executed. The fourth configuration 230 also includes a first agent 232 as the observer agent and a second agent 234 as the planner agent.

FIG. 3 shows a framework 300 implemented by the autonomous construction robot 102 of FIG. 1 (shown as robot 302 in FIG. 3). In embodiments, the framework may be organized into two main modules: a first module 304 pertaining to operations of the hardware components of the robot 302, and a second module 316 comprising pertaining to the AI agents (for example, the one or more AI agents 120, the AI agents shown in FIG. 2, etc.) and associated processing of the robot 302. The first module 304 includes both hardware and software elements. For example, the first module 304 is shown as including a first input component 306 and a second input component 312 of the robot 30. For example, the first input component 306 may be RGB camera(s) and the second input component 312 may be a LiDAR device and/or RGB-depth camera(s). The first module 304 also includes an autonomous navigation software module 308 and a Simultaneous Localization and Mapping (SLAM) software module 310. The second module 316 includes a report generation software module 318, a safety assessment software module 320, a regulation extraction software module 322, and a perceptual software module 324. It should be noted that the specific modules shown in FIG. 3 are merely exemplary and any other combination of modules may be used to facilitate operations of the robot 302. FIG. 3 also shows a communication channel 314, which facilitates the transfer of data from the first module 304 to the second module 316. While the figure shows WebRTC for the communication channel, this is merely exemplary and any other type of communication channel may be used.

The SLAM software module 310 and autonomous navigation software module 308 are foundational capabilities in mobile robotics that enable a robot to move and operate independently in an environment without the need for human teleoperation. From a robotics perspective, SLAM refers to the process by which a robot constructs a map of an unknown environment while simultaneously estimating its own position within that map. Autonomous navigation, on the other hand, builds upon SLAM to allow the robot to plan and execute paths from one location to another safely and efficiently. In the context of construction job sites, where manual robot operation is not scalable or safe, these capabilities play a vital role in enabling physical autonomy, allowing the robot to explore, inspect, or monitor areas without constant human intervention. Within the framework 300, the SLAM software module 310 and autonomous navigation software module 308 build the underlying automation layer that provides spatial awareness and mobility, thereby enabling higher-level AI modules to focus on perception, reasoning, and decision-making.

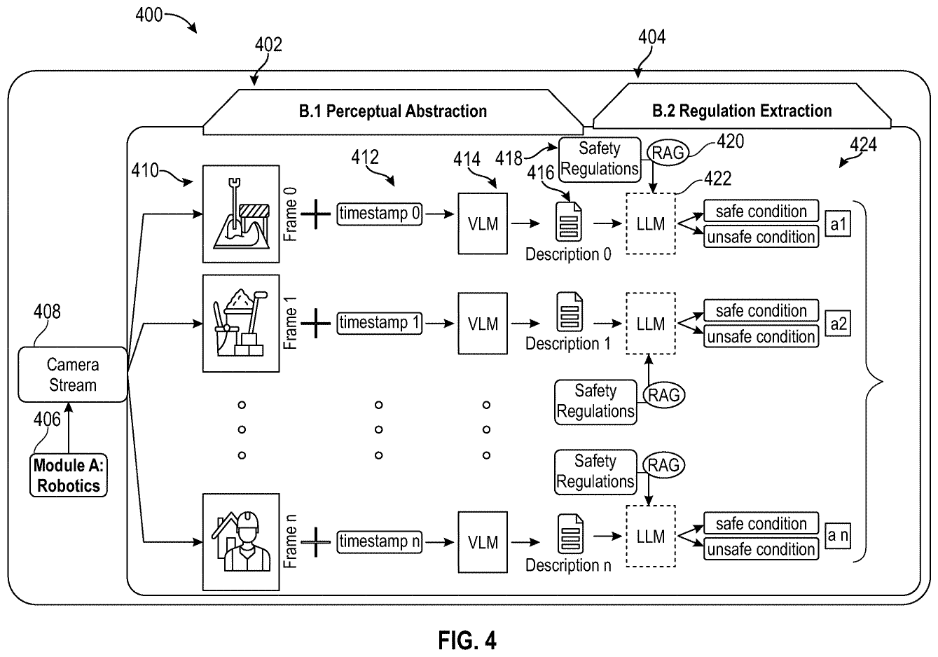

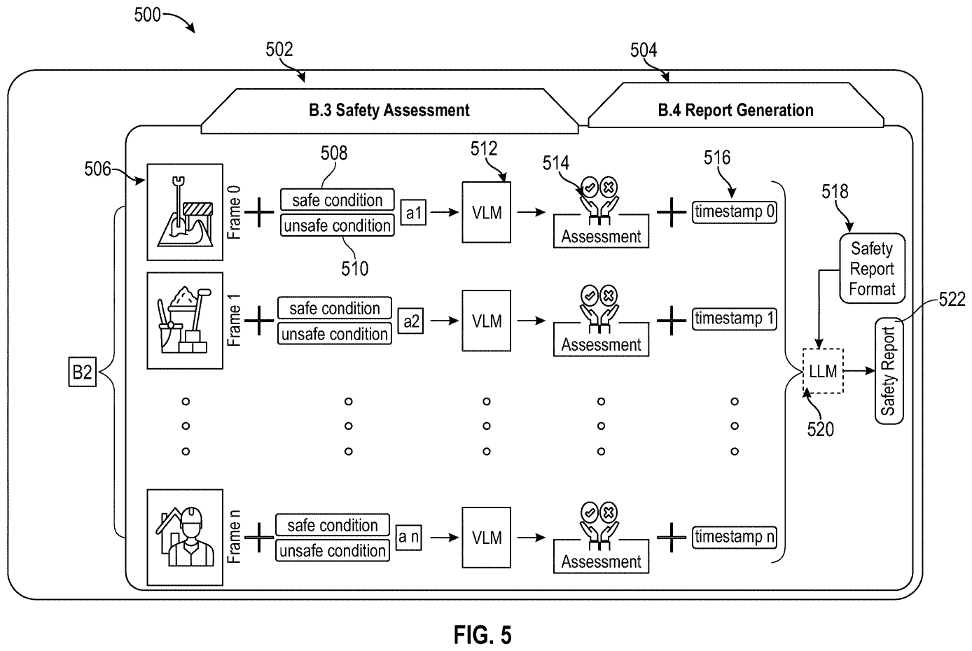

The data flow begins with the robot 302 collecting point cloud information using its onboard LiDAR camera and/or RGB-depth cameras, followed by SLAM processing and autonomous navigation, which together ensure spatial awareness and movement within the environment. Subsequently, the RGB camera may capture image frames that are transmitted to the second module 316, where VLMs generate scene descriptions using the perceptual software module 324, LLMs derive relevant safety regulations using the regulation extraction software module 322, and a second round of visual-language reasoning determines the compliance of each scene with the generated rules using the safety assessment software module 320. Finally, an LLM model consolidates all frame-level safety decisions to generate a comprehensive safety report using the report generation software module 318. These operations are depicted and described in further detail with respect to FIGS. 4-5.

Specifically, in embodiments, the SLAM software module 310 receives raw point cloud data from LiDAR and RGB-D cameras mounted on the robot. Utilizing graph-based SLAM, the system aligns successive sensor readings to estimate the position of the autonomous construction robot 302 over time and to incrementally build a spatial map of the environment. This generated map, along with the real-time odometry of the autonomous construction robot 302, is passed to the autonomous navigation software module 308, which utilizes behavior trees with major components of global planner, local planner, controller, and feedback monitor. The global planner in the framework 300 may use Dijkstra's algorithm to generate a path across a global cost map. While the implementation employs Dijkstra, the framework 300 is also compatible with other search-based planners. The local planner refines this using a local cost map to account for immediate obstacles. The controller translates these plans into specific velocity commands for the autonomous construction robot 302, and the feedback module ensures resilience by adapting to failures, for instance, re-planning paths when unexpected dynamic obstacles appear.

In one or more embodiments, the framework may specifically be built on the Soar cognitive architecture to achieve high-level generalizability and adaptability (however, this is not intended to be limiting and other architectures may be used instead). The Soar cognitive architecture defines the foundational computational building blocks used to achieve human-level intelligent systems for machines, including robotic systems. The system described herein may map Soar's fundamental computational building blocks into specialized, collaborative AI agents. Specifically, the “input link” functions as an observer agent for processing sensory data, the “working memory” operates as a planner agent for task reasoning and sequencing, and the “output link” acts as an actor agent for generating executable motor commands. The framework may integrate Soar's “preference system and impasse resolution” block as a dedicated editor agent. This structural role specialization contributes to reducing errors and refining task execution. This maps collaborative, role-specific cognitive processes to the robot, allowing it to autonomously handle unstructured, and dynamic real-world scenarios of construction tasks.

FIG. 4 shows a flow diagram 400 for perceptual tasks 402 and regulation tasks 404 performed by the construction robot of FIG. 1 (or any other construction robot described herein or otherwise). For example, the perceptual tasks 402 may be tasks performed by the perceptual software module 324 shown in FIG. 3 and the regulation tasks 404 may be tasks performed by the regulation extraction software module 322 shown in FIG. 3.

In embodiments, the perceptual tasks 402 may involve transforming raw visual input from the robot into structured, semantically rich descriptions that can be reasoned about by subsequent components. The process may begin with receiving input data from one or more sensors of the robot. For example, the input data may include video frames 410 received from an RGB camera of the robot, where each frame is tagged with a precise timestamp 412 to maintain temporal alignment with other data streams. These video frames 412 may then be passed through a first language model 414 (which may be a vision language model (VLM) or any other type of model) capable of image captioning and grounded visual understanding, leveraging large-scale multimodal training to identify and describe relevant objects, activities, and spatial relationships within a construction site. This step is beneficial because it transforms low-level pixel and geometry data into textual descriptions 416, enabling downstream language models to apply reasoning and regulatory knowledge without requiring direct image interpretation. Second, the choice of VLMs allows the framework to exploit their core strengths to provide a generalizable description for the dynamic environment of construction sites.

Regulation tasks 404 may involve incorporating context-awareness into the subsequent safety assessment sections by grounding the reasoning process in established safety regulations. Specifically, FIG. 4 shows that the first language model 414 generates descriptions 416 that are then provided as inputs to a second language model (which may be a large language model (LLM) or any other type of model). The second language model 422 may also be provided with any other relevant contextual data as inputs. In the use case described herein pertaining to safety analyses of construction environments, the additional contextual input data may include safety regulations 418. The safety regulations 418 may also be processed using a retrieval-augmented generation (RAG) component 420, which first retrieves the most relevant regulatory clauses (or chunks) from a safety knowledge base (or embedding database). The RAG 420 may be employed for two main reasons: (1) it ensures that the LLM operates with up-to-date and domain-specific safety knowledge without the need for costly retraining, and (2) it constrains the second language model's 422 reasoning to verifiable sources, reducing the risk of hallucination.

The second language model 422 is responsible for interpreting the retrieved regulations in the context of each frame's description, producing a structured output that labels the potential environment (construction site) as (a) safe or (b) unsafe. Apart from the necessity of mentioning unsafe conditions, it is important to provide the context regarding the safe condition as the language model generally relies on the context and may misinterpret without relevant contextual information. This regulatory grounding not only improves the reliability of the safety assessment process (backed with RAG 420 component) but also ensures that every classification is traceable back to a safety rule. That is, using this input data, the second language model 422 may produce one or more outputs.

The one or more outputs 424 may provide an indication that there is an unsafe condition present in the construction environment and/or that there is a safe condition present in the environment. In some instances, the one or more outputs 424 may be a single output indicating either that there is no unsafe condition present anywhere in a given video frame (in which case the output would indicate a safe condition) or that there are one or more unsafe conditions present in the given video frame.

In other cases, the one or more outputs 424 may include indications of multiple safe and/or unsafe conditions identified in the given video frame. The one or more outputs 424, in addition to indicating that safe and/or unsafe condition(s) generally exist, may also provide a description of the specific types of safe and/or unsafe conditions. The description may be provided in any suitable format, such as text-based description, a visual indication in the video frame of the location of the condition, etc.

FIG. 4 shows that there may be multiple models that are configured to analyze video frames in parallel (to reduce processing latency, for example). For example, there may be multiple of the first language model 414 configured to analyze different video frames 410, and multiple second language models 422 configured to analyze the descriptions generated by the multiple first language models 414. However, in some embodiments, a single model may analyze multiple frames in series (for example, there may be one of the first language model 414 and one of the second language model 422).

FIG. 5 shows a flow diagram 500 for safety and report generation tasks performed by the construction robot of FIG. 1 (or any other construction robot described herein or otherwise). For example, the safety tasks 502 may be tasks performed by the safety assessment software module 320 shown in FIG. 3 and the report generation tasks 504 may be tasks performed by the report generation software module 318 shown in FIG. 3.

In embodiments, the safety tasks 502 may leverage the contextual information 418 provided by the previous RAG 420 to determine whether each visual scene captured by the robot meets or violates safety requirements. This stage is central to the framework, with all prior modules serving as foundational steps to ensure that the assessment is both accurate and contextually grounded. Each video frame 506 (which may be the same as the video frames 410 of FIG. 4) is paired with the corresponding set of safety and unsafe conditions generated during the regulation tasks 404 (the one or more outputs 424 of the second language model 422), creating a rule-aware context for analysis. The combined input is then processed by a third language model 512 (which may also be a VLM), which evaluates the video frame 506 against these conditions to produce a safety classification assessment 514, identifying whether the depicted scene is compliant or non-compliant. In addition, each assessment 514 is linked to a precise timestamp 516, ensuring temporal traceability and enabling the integration of sequential safety states in the final reporting stage. This timestamping is beneficial for the report generation tasks 504, where the system summarizes the frame-by-frame assessments into a coherent safety report.

In embodiments, the report generation tasks 504 In this step, a fourth language 520 model (which may also be a LLM) receives the sequence of timestamped safety assessments 514 for each frame, enabling the fourth language model 520 to produce a safety report 522 that not only documents the safety status of each observed moment but also captures patterns and temporal relationships across the entire observation period. This temporal context serves two purposes: first, it supports more accurate and insightful reporting by identifying recurring hazards, and second, it enables the fourth language model 520 to adapt the content into multiple output formats as needed (e.g., structured logs, formal inspection reports, or compliance checklists). In some instances, the fourth language model 520 may also be provided with contextual data 518, including predefined report formatting, which provides the fourth language model 520 with structural guidance, ensuring the generated report follows the expected organization, style, and completeness standards. It should be noted that although reference is made to four different language models in the description of FIGS. 4-5, this does not necessarily mean that these are four distinct models (although in some embodiments, it may). For example, the first language model 414 and third language model 512 may both be the same VLM.

In some instances, the safety tasks 502 may be separated from the report generation tasks 504 in embodiments in which LLMs are used because LLMs tend to perform best when focused on a single reasoning task at a time rather than handling multi-step visual reasoning and long-form summarization simultaneously. By isolating this stage, the framework allows earlier modules to specialize in perception, rule grounding, and safety classification, while reserving the LLM in the regulation extraction tasks 504 for synthesizing coherent, contextually rich narratives from structured inputs.

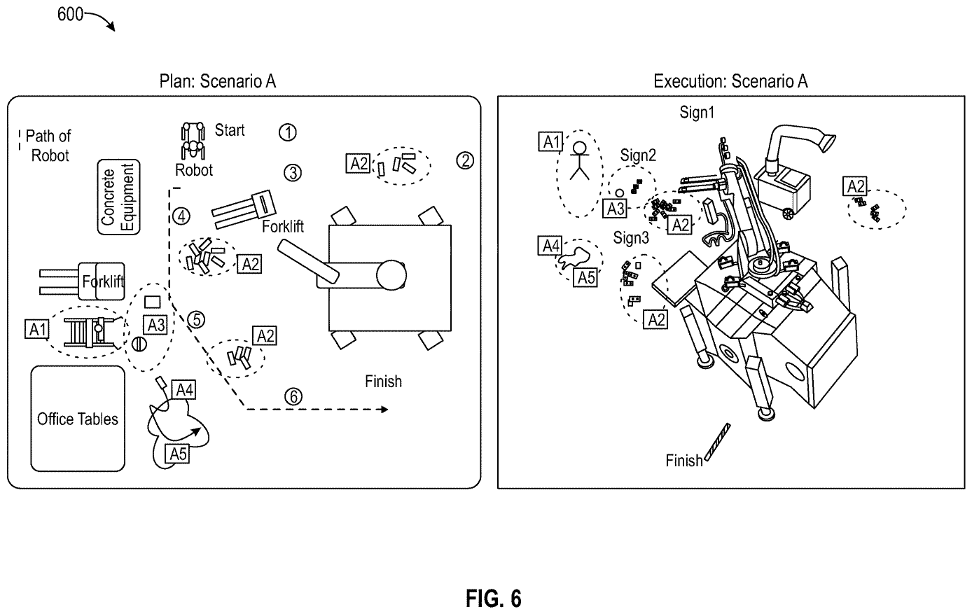

FIG. 6 shows an example of a use case 600 performed by the construction robot of FIG. 1. The use case 600 shows a planned route (left) for an autonomous construction robot 602 and its real-world implementations (right). In this scenario, the autonomous construction robot 602 began from a designated starting point and then followed a predefined navigation path that systematically exposed the autonomous construction robot 602 to hazards of multiple categories. As the autonomous construction robot 602 navigated through the environment, the autonomous construction robot 602 encountered hazards from multiple categories.

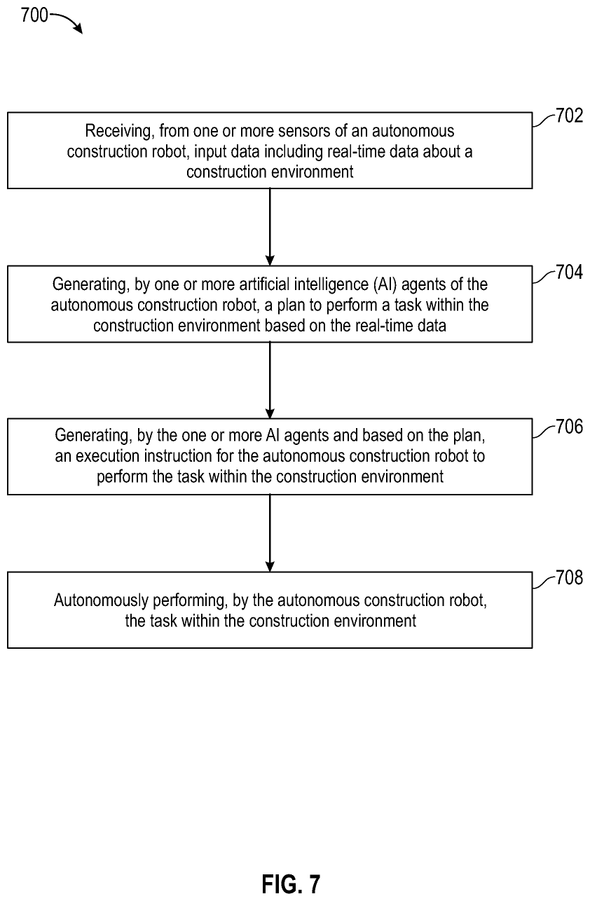

FIG. 7 is a method 700 for multi-agents for adaptable task planning in construction robots. It is understood that the method 700 of FIG. 7 provides merely an example of the many different types of functional arrangements that may be employed to implement the operation of the portion of the autonomous construction robot (such as autonomous construction robot 102, etc.) as described herein. At step 702 of the method 700, the autonomous construction robot may receive, from one or more sensors of an autonomous construction robot, input data including real-time data about a construction environment. At step 704 of the method 700, the autonomous construction robot may generate, by one or more artificial intelligence (AI) agents of the autonomous construction robot, a plan to perform a task within the construction environment based on the real-time data. At step 706 of the method 700, the autonomous construction robot may generate, by the one or more AI agents and based on the plan, an execution instruction for the autonomous construction robot to perform the task within the construction environment. At step 708 of the method 700, the autonomous construction robot may autonomously perform the task within the construction environment.

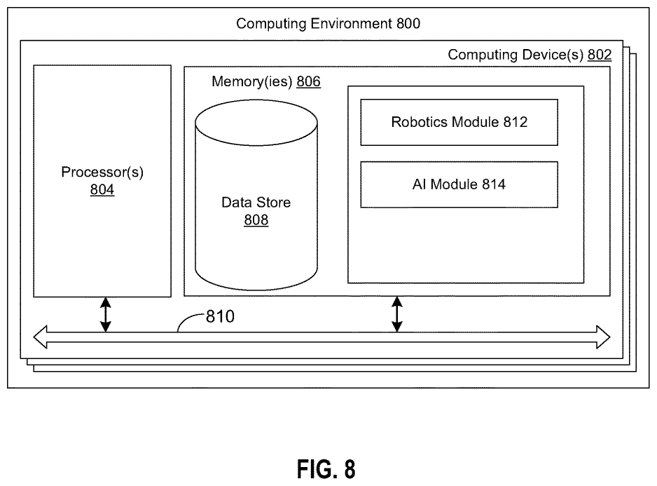

With reference to FIG. 8, shown is a schematic block diagram of a computing environment according to an embodiment of the present disclosure. The computing environment includes one or more computing devices 802. A computing device may be implemented within an autonomous construction robot (for example, autonomous construction robot 102 or any other robot described herein). The computing device 802 may also described components that may be included in any other device with processing capabilities as described herein, such as remote computing device 108, for example. Each computing device 802 includes at least one processor circuit, for example, having a processor 804 and a memory 806, both of which are coupled to a local interface 810. To this end, each computing device 802 may comprise, for example, at least one server computer or like device. The local interface 810 may comprise, for example, a data bus with an accompanying address/control bus or other bus structure as can be appreciated.

Stored in the memory 806 are both data and several components that are executable by the processor 804. In particular, stored in the memory 806 and executable by the processor 804 are a c (which may be the same as robotics module 304 and AI module 316), and potentially other applications. Also stored in the memory 806 may be a data store 808 and other data. In addition, an operating system may be stored in the memory 806 and executable by the processor 804.

It is understood that there may be other applications that are stored in the memory 806 and are executable by the processor 804 as can be appreciated. Where any component discussed herein is implemented in the form of software, any one of a number of programming languages may be employed such as, for example, C, C++, C#, Objective C, Java®, JavaScript®, Perl, PHP, Visual Basic®, Python®, Ruby, Flash®, or other programming languages.

A number of software components are stored in the memory 806 and are executable by the processor 804. In this respect, the term “executable” means a program file that is in a form that can ultimately be run by the processor 804. Examples of executable programs may be, for example, a compiled program that can be translated into machine code in a format that can be loaded into a random access portion of the memory 806 and run by the processor 804, source code that may be expressed in proper format such as object code that is capable of being loaded into a random access portion of the memory 806 and executed by the processor 804, or source code that may be interpreted by another executable program to generate instructions in a random access portion of the memory 806 to be executed by the processor 804, etc. An executable program may be stored in any portion or component of the memory 806 including, for example, random access memory (RAM), read-only memory (ROM), hard drive, solid-state drive, USB flash drive, memory card, optical disc such as compact disc (CD) or digital versatile disc (DVD), floppy disk, magnetic tape, or other memory components.

The memory 806 is defined herein as including both volatile and nonvolatile memory and data storage components. Volatile components are those that do not retain data values upon loss of power. Nonvolatile components are those that retain data upon a loss of power. Thus, the memory 806 may comprise, for example, random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, the RAM may comprise, for example, static random access memory (SRAM), dynamic random access memory (DRAM), or magnetic random access memory (MRAM) and other such devices. The ROM may comprise, for example, a programmable read-only memory (PROM), an erasable programmable read-only memory (EPROM), an electrically erasable programmable read-only memory (EEPROM), or other like memory device.

Also, the processor 804 may represent multiple processors 804 and/or multiple processor cores and the memory 806 may represent multiple memories 806 that operate in parallel processing circuits, respectively. In such a case, the local interface 810 may be an appropriate network that facilitates communication between any two of the multiple processors 804, between any processor 804 and any of the memories 806, or between any two of the memories 806, etc. The local interface 810 may comprise additional systems designed to coordinate this communication, including, for example, performing load balancing. The processor 804 may be of electrical or of some other available construction.

Although the robotics module 812 and AI module 814, and other various systems described herein may be embodied in software or code executed by general purpose hardware as discussed above, as an alternative the same may also be embodied in dedicated hardware or a combination of software/general purpose hardware and dedicated hardware. If embodied in dedicated hardware, each can be implemented as a circuit or state machine that employs any one of or a combination of a number of technologies. These technologies may include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc. Such technologies are generally well known by those skilled in the art and, consequently, are not described in detail herein.

The method 700 of FIG. 7 shows the functionality and operation of an implementation of portions of the robotics module 812 and AI module 814. If embodied in software, each block may represent a module, segment, or portion of code that comprises program instructions to implement the specified logical function(s). The program instructions may be embodied in the form of source code that comprises human-readable statements written in a programming language or machine code that comprises numerical instructions recognizable by a suitable execution system such as a processor 804 in a computer system or other system. The machine code may be converted from the source code, etc. If embodied in hardware, each block may represent a circuit or a number of interconnected circuits to implement the specified logical function(s).

Although the method 700 of FIG. 7 shows a specific order of execution, it is understood that the order of execution may differ from that which is depicted. For example, the order of execution of two or more blocks may be scrambled relative to the order shown. Also, two or more blocks shown in succession in the method 700 of FIG. 7 may be executed concurrently or with partial concurrence. Further, in some embodiments, one or more of the blocks shown in FIG. 7 may be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein, including the robotics module 812 and AI module 814, that comprises software or code can be embodied in any non-transitory computer-readable medium for use by or in connection with an instruction execution system such as, for example, a processor 804 in a computer system or other system. In this sense, the logic may comprise, for example, statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system.

The computer-readable medium can comprise any one of many physical media such as, for example, magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium may be a random access memory (RAM) including, for example, static random access memory (SRAM) and dynamic random access memory (DRAM), or magnetic random access memory (MRAM). In addition, the computer-readable medium may be a read-only memory (ROM), a programmable read-only memory (PROM), an erasable programmable read-only memory (EPROM), an electrically erasable programmable read-only memory (EEPROM), or other type of memory device.

Further, any logic or application described herein, including the robotics module 812 and AI module 814, may be implemented and structured in a variety of ways. For example, one or more applications described may be implemented as modules or components of a single application. Further, one or more applications described herein may be executed in shared or separate computing devices or a combination thereof. For example, a plurality of the applications described herein may execute in the same computing device 802, or in multiple computing devices in the same computing environment 103. Additionally, it is understood that terms such as “application,” “service,” “system,” “engine,” “module,” and so on may be interchangeable and are not intended to be limiting.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

Therefore, the following is claimed:

1. An autonomous construction robot, comprising:
one or more sensors;
one or more processors; and
memory storing instructions which, when executed by the processor, cause the processor to perform operations comprising:
receiving, from the one or more sensors, input data including real-time data about a construction environment;
generating, by one or more artificial intelligence (AI) agents of the autonomous construction robot, a plan to perform a task within the construction environment based on the real-time data;
generating, by the one or more AI agents and based on the plan, an execution instruction for the autonomous construction robot to perform the task within the construction environment; and
autonomously performing, by the autonomous construction robot, the task within the construction environment.

2. The autonomous construction robot of claim 1, wherein the one or more AI agents comprise a first AI agent configured to receive and analyze the input data and generate the plan, and a second AI agent configured to receive the plan from the first AI agent and generate the execution instruction.

3. The autonomous construction robot of claim 1, wherein the one or more AI agents comprise a first AI agent configured to receive and analyze the input data, a second AI agent configured to receive an analysis from the first AI agent and generate the plan, and a third AI agent configured to receive the plan from the second AI agent and generate the execution instruction.

4. The autonomous construction robot of claim 1, wherein the one or more AI agents comprise a first AI agent configured to receive and analyze the input data, a second AI agent configured to receive an analysis from the first AI agent and generate the plan, a third AI agent configured to receive the plan from the second AI agent and generate the execution instruction, and a fourth AI agent configured to edit the plan via interactions with at least one of the second AI agent or the third AI agent.

5. The autonomous construction robot of claim 1, wherein the input data also includes at least one of: project documentation or a robot software development kit (SDK).

6. The autonomous construction robot of claim 1, wherein the instructions further cause the processor to perform operations comprising:
receiving a video frame from the one or more sensors;
determining a timestamp associated with the video frame;
providing the video frame and the timestamp to a first language model;
generating, by the first language model, a description of the video frame;
providing the description of the video frame and information about safety regulations to a second language model; and
generating, by the second language model, an output, the output including an indication that at least one of: a safe condition exists in the construction environment or an unsafe condition exists in the construction environment.

7. The autonomous construction robot of claim 6, wherein the instructions further cause the processor to perform operations comprising:
providing the video frame and the output from the second language model to a third language model;
generating, by the third language model, an assessment and a second timestamp;
providing the assessment and the second timestamp to a fourth language model; and
generating, by the fourth language model, a safety report pertaining to the construction environment.

8. The autonomous construction robot of claim 7, wherein the first language model and third language model are vision language models (VLMs), and wherein the second language model and the fourth language model are large language models (LLMs).

9. A system comprising:
an autonomous construction robot, comprising:
one or more sensors;
one or more processors; and
memory storing instructions which, when executed by the processor, cause the processor to perform operations comprising:
receiving, from the one or more sensors, input data including real-time data about a construction environment;
generating, by one or more artificial intelligence (AI) agents of the autonomous construction robot, a plan to perform a task within the construction environment based on the real-time data;
generating, by the one or more AI agents and based on the plan, an execution instruction for the autonomous construction robot to perform the task within the construction environment, wherein the one or more AI agents comprise a first AI agent configured to receive and analyze the input data and generate the plan, and a second AI agent configured to receive the plan from the first AI agent and generate the execution instruction; and
autonomously performing, by the autonomous construction robot, the task within the construction environment.

10. The system of claim 9, wherein the one or more AI agents comprise first AI agent configured to receive and analyze the input data, a second AI agent configured to receive an analysis from the first AI agent and generate the plan, and a third AI agent configured to receive the plan from the second AI agent and generate the execution instruction.

11. The system of claim 9, wherein the one or more AI agents comprise a first AI agent configured to receive and analyze the input data, a second AI agent configured to receive an analysis from the first AI agent and generate the plan, a third AI agent configured to receive the plan from the second AI agent and generate the execution instruction, and a fourth AI agent configured to edit the plan via interactions with at least one of the second AI agent or the third AI agent.

12. The system of claim 9, wherein the input data also includes also includes at least one of: project documentation or a robot software development kit (SDK).

13. The system of claim 9, wherein the instructions further cause the processor to perform operations comprising:
receiving a video frame from the one or more sensors;
determining a timestamp associated with the video frame;
providing the video frame and the timestamp to a first language model;
generating, by the first language model, a description of the video frame;
providing the description of the video frame and information about safety regulations to a second language model; and
generating, by the second language model, an output, the output including an indication that at least one of: a safe condition exists in the construction environment or an unsafe condition exists in the construction environment.

14. The system of claim 13, wherein the instructions further cause the processor to perform operations comprising:
providing the video frame and the output from the second language model to a third language model;
generating, by the third language model, an assessment and a second timestamp;
providing the assessment and the second timestamp to a fourth language model; and
generating, by the fourth language model, a safety report pertaining to the construction environment.

15. The system of claim 14, wherein the first language model and third language model are vision language models (VLMs).

16. The system of claim 14, wherein the second language model and the fourth language model are large language models (LLMs).

17. A method comprising:
receiving, from one or more sensors of an autonomous construction robot, input data including real-time data about a construction environment;
generating, by one or more artificial intelligence (AI) agents, a plan to perform a task within the construction environment based on the real-time data;
generating, by the one or more AI agents and based on the plan, an execution instruction for the autonomous construction robot to perform the task within the construction environment; and
autonomously performing, by the autonomous construction robot, the task within the construction environment.

18. The method of claim 17, wherein the one or more AI agents comprise a first AI agent configured to receive and analyze the input data and generate the plan, and a second AI agent configured to receive the plan from the first AI agent and generate the execution instruction.

19. The method of claim 17, wherein the one or more AI agents comprise a first AI agent configured to receive and analyze the input data, a second AI agent configured to receive an analysis from the first AI agent and generate the plan, and a third AI agent configured to receive the plan from the second AI agent and generate the execution instruction.

20. The method of claim 17, wherein the one or more AI agents comprise a first AI agent configured to receive and analyze the input data, a second AI agent configured to receive an analysis from the first AI agent and generate the plan, a third AI agent configured to receive the plan from the second AI agent and generate the execution instruction, and a fourth AI agent configured to edit the plan via interactions with at least one of the second AI agent or the third AI agent.
